(19) United States
(12) Patent Application Publication
(10) Pub. No.: US 2005/0266120 A1
(43) Pub. Date: Dec. 1, 2005

(54) Method for producing beer-like and alcohol-free fermented beverage

(76) Inventors: Tzann-Feng Lin, Taipei City (TW); Ying-Lung Chen, Banciao City (TW); Tseng-Hsing Wang, Jhonghe City (TW)

Correspondence Address: BIRCH STEWART KOLASCH & BIRCH, PO BOX 747, FALLS CHURCH, VA, 22040-0747, US

(21) Appl. No.: 10/862,355

(22) Filed: Jun. 8, 2004

(30) Foreign Application Priority Data
May 25, 2004 (TW) 093114797

(51) Int. Cl. C12G 3/08

(52) U.S. Cl. 426/49; 426/52

(57) ABSTRACT

A method for producing a beer-like and alcohol-free fermented beverage that contains very small amount of alcohol mainly employs the fermentative fungi such as a genus of Monascus that can slowly ferment alcohol and has high anti-oxidation activity to control fermentation of alcohol. The method includes mixing pale malt and roasted malt of barley to produce wort; adding Aroma hops into the wort; adjusting sugar content and bitterness; then adding Anka that has high anti-oxidation activity and has been cultivated according to conventional methods to proceed a controlled fermentation for a short period of time; separating the Anka and fermenting the separated wort at temperature of 4° C.; then filtering the wort, and sterilizing and packaging the beverage. The fermented beverage thus produced looks like beer and has a refreshing taste, glittering red color but contains no alcohol.

### BACKGROUND OF THE INVENTION

1. Field of the Invention

The invention relates to a method that uses the fermentative fungi such as a genus of Monascus that ferment alcohol slowly to produce a beer-like and alcohol-free fermented beverage.

2. Description of the Prior Art

Beer is the largest consumed alcohol-containing beverage in the world today. For consumers who cannot drink beer or in occasions where beer is prohibited, a beer-like beverage produced through mashing and fermentation of nature wort without alcohol is a desirable substitute for beer. It not only has the rich flavor of malt and beer-like foams, also contains a trace of roasted aroma, and gives people a smooth taste and juicy feeling. Hence it is well accepted by consumers who like the flavor of beer but do not want to consume too much alcohol and many other people. The ingredients for producing beer generally include barley and aroma hops that go through the processes of malting, mashing and fermentation to become a brewed beverage containing alcohol less than 0.5%. Many people see it as a refreshing drink. It generally has alcohol content between 0.2 to 0.5%.

The characteristic of beer is its strong scent of malt and aroma hops, and pure and refreshing taste. Beer contains a great amount of carbon dioxide and rich nutritious ingredients. It is helpful for digestion, can improve appetite and gives people refreshing and relaxing feeling. Hence it is deeply loved by many people. Moreover, beer contains eleven vitamins and seventeen amino acids. After digestion, one liter of beer can generate calorie equivalent to ten chicken eggs or five hundred grams of meat, or two hundred milliliter of milk. Thus it is also called “liquid milk”. Beer generally can be categorized as follows:

1. Raw beer and heat-treat beer depending on whether the beer has been sterilized on not. The raw beer is also called draft beer, and is not sterilized. Its preservation period is shorter, and generally ranges from three days to seven days under the temperature of 15° C. It tastes fresh, and is widely loved by consumers. The heat-treat beer has been sterilized. It is more stable and has a longer preservation period which could last three months or more. However its taste and nutrition is inferior to the raw beer.

2. Low concentration, medium concentration and high concentration beer depending on the concentration of wort before fermentation. The low concentration beer use 7 to 8 percent concentration of wort, the medium concentration beer use 10 to 12 percent and the high concentration beer use 14 to 20 percent. The alcohol content of beer increases as the concentration of the wort increases. The low concentration beer has about 2% of alcohol, the medium concentration beer has about 3.1 to 3.8% of alcohol, and the high concentration beer has about 4 to 5% of alcohol.

3. Yellow beer, black beer and white beer are named by the color of beer. The yellow beer also is called light beer which tastes light and soothing. Most beers now being produced are in this category. The hue of color varies in different producing locations. The black beer also is called dark beer which has the color of coffee. It has glittering light and strong taste, and tinges with a charred scent. The yield is less than yellow beer. The white beer looks mostly white. It differs from other types of beer in that its ingredient includes wheat, and it tastes sourer, thus can better quench thirst.

4. Depending on alcohol content, then is beer and non-alcoholic beer. The non-alcoholic beer is a break-through of beer brewing technology in recent years. It maintains the original flavor of beer but does not contain alcohol, thus is widely accepted on the market.

The non-alcoholic beer must contain alcohol less than 0.5% v/v. Its production methods can be divided in physical methods or fermentation control methods. The physical methods include thermal process (such as vacuum concentrating), film separation (such as reverse osmosis and dialysis) and freeze-dried method that can remove alcohol. The latter can inhibit production of alcohol by controlling the fermentation. It includes many approaches, such as use Saccharomyces ludwigu that does not utilize maltose or disable yeast through cryogenic contact to inhibit production of alcohol; reduce wort concentration by using low-carbohydrate fermentation that converts less maltose to alcohol; and cultivate a special wort by adjusting pH, increasing boiling time and adding roast malt to reduce the raw starch flavor of the non-fermented wort.

When adopting the physical method the cost is high. In the fermentation control method, alcohol fermentation of yeast often takes place rapidly and the process is quite difficult to control. A slightly improper handling could result in the alcohol concentration exceeding 0.5% v/v.

### SUMMARY OF THE INVENTION

The primary object of the present invention is to provide a method to produce a beer-like and alcohol-free fermented beverage that contains very little alcohol. It uses the fermentative fungi that ferment alcohol slowly. When it is blended with natural wort, a beer-like and alcohol-free fermented beverage with a strong fermented aroma but with the alcohol content less than 0.5%(v/v) could be produced.

In one aspect, the fermentative fungi used in the invention belonging to a genus of Monascus such as Monascus purpureus. The fungi can produce nature bright red color and is an excellent conventional food colorant. It is stable and heat resistant, and has a strong coloring power on protein foodstuff. It is proved safe and bactericidal. Anka (Monascus-grown rice) is widely used in Japan for coloring protein foodstuff. It also has been widely used in China since ancient time up to present for manufacturing roasted red pork, Chinese-style red sausage, and the like. Monascus also produces enzyme that can decompose starch, produce alcohol and decompose protein. It the oriental countries, it also being used to produce red rice wine (Anchiew is included) and red fermented bean curd and the like.

Monascus also can produce a wide range of secondary metabolites including anti-oxidants and cholesterol-lowering agents and other health improving components (reference can be found in Kuramoto, Y., et al., 1997, U.S. Pat. No. 5,627,068; Herber, D., et al., 1999, Am. J. Clin. Nutr., 69 : 231-236; Lin, 2001, Wonderful therapeutic effects of Anka, Cool Books Publication Co. Taiwan, R.O.C.)

The characteristic of the invention is to use the fermentative fungi such as a genus of Monacus that ferment alcohol slowly and have high anti-oxidation activity to replace the conventional yeast so that concentration of alcohol being produced can be controlled as desired and produce a beer-like and alcohol-free fermented beverage. This method extends cultivation of Anka (Monascus-grown rice) by two to three days more than the method used in the conventional brewing process. After the Anka with high anti-oxidation activity has been produced, they are added into wort. Under anaerobic environment, the Anka ferment for a short period of time, nutrients that are necessary for human body such as oligo-saccharide, amino acid, unsaturated fatty acid and vitamins are retained. After the fermentation and aging processes, the original raw starch flavor of the wort is changed and transformed to a refreshing taste. In addition, Anka contain rich nature red color and health improving ingredients. Thus the beer-like and alcohol-free fermented beverage thus produced also is a nutritious and health improving drink.

The foregoing, as well as additional objects, features and advantages of the invention will be more readily apparent from the following detailed description.

### DESCRIPTION OF THE PREFERRED EMBODIMENT

The present invention employs the selected fermentative fungi such as Monascus purpureus that are frequently used by oriental people for processing foods that have the properties of fermenting alcohol slowly and strong anti-oxidation activity to substitute the yeast to cultivate fermentation and produce an alcohol-free beverage which has the flavor and taste of beer. The production method includes adding Anka to wort used in the general beer brewing process, and after a short metabolic reaction, separating the Anka in the condition where the alcohol concentration in no higher than 0.5%(v/v). Such a process can remove the raw starch flavor of the original wort. After having been transformed through fermentation and aging processes, can produce a health improving drink that has a refreshing taste, contains red colorant and rich nutrients. The antioxidant can make Monascus colorant stable in the room temperature for 4 to 6 months.

The beer-like and alcohol-free fermented beverage according to the invention is produced by using Anka that can ferment alcohol and has high anti-oxidation activity, and has glittering red color and contains health improving nutrients existing in the wort and Anka. Both its appearance and content are novel, and it differs greatly from the alcohol-free beer produced by other methods.

An embodiment of the method of the invention for producing the beer-like and alcohol-free fermented beverage includes the steps as follow:

The Preparation of Anka

Steamed rice was inoculated with Monascus purpureus TMB 9301 at an inoculation amount to result in 100 spores/kg raw rice, or 2-5% of the steamed rice by weight. The inoculated rice was cultivated at about 30 degree C. for 5-7 days until the steamed rice turned a deep red color. The colored rice was used as seed koji.

The seed koji was uniformly mixed with steamed rice at a ratio of 3% by weight based on the weight of steamed rice. At a temperature of 30-37 degree C. and a relative humidity of 90-95%, the resulting mixture was soaked in water twice and cultivated for 6 days to produce Anka with a bright red color and contains nature anti-oxidants.

To evaluate the antioxidation activity of Anka used in the method of the invention, we choose two free radical scavenging analysis. First one is scavenging of radical cation 2,2-azinobis-(3-ethylbenzothiazoline-6-sulphonate) or the ABTS method (Rice-Evans, C. A. and Miller N. J. 1994 Methods in Enzymology, 23:279-293), in which TEAC (Trolox Equivalent Antioxidant Capacity) must be more than 250 for each gram of sample. The other one is the scavenging of stable radical 2,2-diphenyl-1-picrylhydrazyl or DPPH method. (Yamaguchi, T. et al. 1998 Biosci. Biotechnol. Biochem. 62:1201-1204), in which TEAC must be more than 25 for each gram of sample.

Malting:

Place washed barley in a container to allow the barley to absorb moisture and oxygen needed for sprouting in a controlled temperature and humidity. After the barley has sprouted as desired, dry the barley by heated air at 70-80° C. and grind the barley into powder.

Mashing:

Put the ground malt into a mashing tun, mix pale malt and roasted malt in the ratio of 5-100:1, preferably 30:1; add hot water with increasing temperature of 45° C. (30 minutes)→54° C. (40 minutes )→62° C. (50 minutes)→72° C. (60 minutes)→78° C. (10 minutes) to gradually mashing which activate the enzyne in the malt to decompose the starch and result in production of wort.

Boiling Wort:

Filter the wort, and boil the wort and add Aroma hops during boiling, adjust sugar content in the range of 4-15 Plato, preferably 12 Plato, and bitter unit in the range of 4-10 B.U., preferably 6 B.U. to enable the wort to contain the scent and bitter taste of Aroma hops. The aroma hops may be selected from Hallertau Hersbruck Hallertau Perle Slovenia Styrian Golding and Saaz Saazer.

Fermenting:

Cool the wort to room temperature, add 1% w/w of Anka, mix thoroughly; ferment at room temperature between 20-25° C. in a still condition for 1-3 day, preferably 2 days; control the sugar content at about 1 Plato with the alcohol content not exceeding 0.5% v/v, then stop fermentation, and separate the Anka from the fermented wort.

Resting, Filtering and Bottling:

Fill carbon dioxide in the fermented wort until reaching the pressure of 1.5-2 kg/cm²; keep the wort still at temperature of 4° C. for post-fermenting 1-2 weeks, then filter the wort and sterilize and bottle the beverage.

Processing the Residue:

The residue remained after fermentation and filtering processes mentioned above may be added 0.01-0.1% of acid protease and yeast to ferment the alcohol for 2-3 weeks. The resulting substance is the so called “Anka paste” which has a strong fermenting aroma and can be used to preserve vegetable and fruits, or process meat.

While the preferred embodiment of the invention has been set forth for the purpose of disclosure, modifications of the disclosed embodiment of the invention as well as other embodiment thereof may occur to those skilled in the art. Accordingly, the appended claims are intended to cover all embodiments which do not depart from the spirit and scope of the invention.

1. A method for producing a beer-like and alcohol-free fermented beverage employing a slow fermentation process, comprising the steps of:
adding fermentative fungi into wort for fermenting in a still;
stopping fermentation when alcohol content of the wort is less than 0.5% (v/v), and separating the fermentative fungi from the fermented wort; and
filling carbon dioxide into the fermented wort and storing the wort in a container at a condition of increased pressure.

2. The method of claim 1, wherein the wort is fermented with the fermentative fungi for 2-3 days.

3. The method of claim 1, wherein the pressure in the container is 1.5-2 kg/cm².

4. The method of claim 1, wherein the fermentative fungi is 1-10% w/w of the wort.

5. The method of claim 1, wherein the wort is fermented with the fermentative fungi at a temperature between 20° C. and 25° C.

6. The method of claim 1, wherein the fermented wort contains alcohol ranging from 0.05% to 0.45% (v/v).

7. The method of claim 1, wherein the wort is a mixture of pale malt and roasted malt.

8. The method of claim 7, wherein the mixture contains the pale malt and roasted malt in the ratio of 5-100:1.

9. The method of claim 8, wherein the mixture contains the pale malt and roasted malt in an optimal ratio of 30:1.

10. The method of claim 1, wherein the wort further includes Aroma hops.

11. The method of claim 10, wherein the Aroma hops is selected from the group consisting of Hallertau Hersbruck, Hallertau Perle, Slovenia Styrian Golding and Saaz Saazer.

12. The method of claim 1, wherein the mash has sugar content in the range of 4-15 Plato.

13. The method of claim 1, wherein the mash has bitterness in the range of 4-10 bitter unit (B.U.).

14. The method of claim 1, wherein the fermentative fungi is genus Monascus.

15. The method of claim 14, wherein the Monascus is cultivated by the steps of:
inoculating Monascus purpureus TMB to steamed rice at the quantity of 100 spores for every kilogram of rice, and cultivating for 5-7 days at temperature 30° C. to produce seed koji; and
mixing evenly 3% of the seed koji by weight with rice, and cultivating for 7-9 days at a temperature of 30-37° C. and a relative humidity below 90-95%, and soaking in water twice during the cultivating period.

16. The method of claim 1, wherein the stored fermented wort is subject to post-fermentation for 1-2 weeks at a temperature of 4° C.
